(19) United States
(12) Patent Application Publication
(10) Pub. No.: US 2005/0254072 A1
(43) Pub. Date: Nov. 17, 2005

(54) Image data processing method, client terminal, image processing program, image data management method and image management system

(75) Inventors: Yoshiyuki Hirai, Tokyo (JP); Takuya Kotani, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/126,192

(22) Filed: May 11, 2005

(30) Foreign Application Priority Data
May 12, 2004 (JP) 2004-141767
Nov. 15, 2004 (JP) 2004-329905

(51) Int. Cl. G06F 15/00

(52) U.S. Cl. 358/1.2

(57) ABSTRACT

The invention manages image data by an original image file including high-resolution image data stored in a specified storage location on a server or a client terminal, a shortcut image file including an address tag indicating the storage location of the original image file and low-resolution image data representing a summary of the high-resolution image data of the original image file. For utilizing the high-resolution image data, the original image file is acquired based on the address tag included in the shortcut image file. Also depending on whether the acquisition is possible or not, for example if the original image file cannot be acquired, the low-resolution image data contained in the shortcut image file are acquired as a substitute.

### BACKGROUND OF THE INVENTION

1. Field of the Invention

The present invention relates to a management method for managing plural image data having different data sizes for a specified image, a client terminal, an image management program, an image data management method for a partitionary management of image data in a client terminal, and an image management system having a client terminal and a server connected to a network.

2. Description of the Related Art

In the image management method, there is known an image format corresponding to a DCF standard, in which original image data of a high-resolution and thumbnail image data of a low-resolution are stored in a single image file.

The DCF (Design rule for Camera File system), which is an ISO standard image format for a digital camera, is in conformity with the Exif (Exchangeable Image File) standard of JEIDA, and the image formats of such DCF and Exit standards can be considered almost same.

An image file of the DCF/Exif standard has a structure in which main image data, thumbnail image data and photographing information are embedded in a form according to the JPEG standard. Such image management method provides an advantage that the image data to be accessed can be selected according to the purpose of use. For example the original image data of high-resolution are accessed to know a detailed image, and the thumbnail image data of low-resolution are accessed in case only a rough image is required.

On the other hand, the aforementioned image management method, in which the thumbnail image data of low-resolution and the original image data of high-resolution are constructed as a single image file, is associated with a drawback that the image file of a large file size including the original image data of a large data size has to be handled even when only a summary of the image is necessary and the original image data of high-resolution are not referred.

An efficiency of file size of an image file to be transmitted or received is important particularly in a data communication such as an e-mail or a facsimile. Therefore, for example U.S. Pat. No. 6,101,526 proposes a method in which a link for accessing to thumbnail image data of low-resolution or original image data of high-resolution is transmitted by an e-mail, and a recipient obtains the original image data of high-resolution utilizing such link described in the e-mail, only when such original image data of high-resolution are necessary.

However, in such image management method described in U.S. Pat. No. 6,101,526, the link for accessing to the original image data of high-resolution is stored in the main text of the e-mail. Consequently, the main text of the e-mail describing the link is necessary for obtaining the original image data of high-resolution. Thus the original image data of high-resolution cannot be accessed in case the main text of the e-mail is erased.

Also there are known methods, such as shortcut, alias, symbolic link or hyperlink, of referring to a content of an image file through a link file that is separated from the content of the image file and indicates a storage location of the content, but such methods involve following drawbacks.

At first, in case of a hyperlink in an HTML (Hyper Text Markup Language), a URL (URI) information indicating a storage location of main image data of an image file has to be described in an HTML language of text base. Also for indicating a summary of the main image data of the image file on a client terminal, there are required cumbersome operations of preparing thumbnail image data, obtained for example by reducing the main image data of the image file, and describing the URL (URI) information indicating a storage location thereof in an HTML language.

Also in case of a shortcut file, in order to know a summary of main image data of an image file, it is necessary to separately refer to an image management file for the main image data of the image file, constituting a subject of a shortcut file such as a system file of an OS (operating system), and the main image data of the image file cannot be accessed from the shortcut file only.

### SUMMARY OF THE INVENTION

In consideration of the foregoing situation, an object of the present invention is to separately and securely manage image data of a high-resolution and image data of a low-resolution while maintaining a relationship therebetween, by a simple and inexpensive configuration.

Another object of the present invention is to enable, in a client terminal, to obtain, in conformity with an image file of a small file size, a corresponding image file of a larger file size containing original image data of a high-resolution in an extremely easy manner.

In order to attain the above-described objects of the present invention, according to aspect of the present invention, an image data management method of the present invention for managing image data of a high-resolution included in an original image file, comprising: an acquisition step of acquiring image data of a low-resolution, corresponding to the image of the high-resolution; a preparation step of preparing a shortcut image file including the acquired image data of the low-resolution; and an attaching step of attaching, to the prepared shortcut image file, an address tag indicating a location where the original image file is stored.

According to another aspect of the present invention, an image data management apparatus of the present invention, for managing image data of a high-resolution included in an original image file, comprising: acquisition means which acquires image data of a low-resolution, corresponding to the image of the high-resolution; preparation means which prepares a shortcut image file including the acquired image data of the low-resolution; and attaching means which attaches, to the prepared shortcut image file, an address tag indicating a location where the original image file is stored.

According to still another aspect of the present invention, an image data transfer process method of the present invention, comprising: an acquisition step of acquiring an address tag indicating a storage location of an original image file including image data of a high-resolution, in which the shortcut image file includes image data of a low-resolution corresponding to the image data of the high-resolution; and a request step of requesting a transfer of the image data of the high-resolution of the original image file in conformity with the address tag.

According to still another aspect of the present invention, an image data transfer processing apparatus of the present invention, comprising: acquisition means which acquires an address tag indicating a storage location of an original image file including image data of a high-resolution, in which the shortcut image file includes image data of a low-resolution corresponding to the image data of the high-resolution; request means which requests a transfer of the image data of the high-resolution of the original image file in conformity with the address tag.

Other features and advantages of the present invention will become apparent from the following description which is to be taken in conjunction with the accompanying drawings, in which like reference characters designate the same or similar parts throughout the figures.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a view showing structures of an original image file and a shortcut image file to be used in an image management of the present invention;

FIG. 2 is a view showing a structure of an address tag attached to the shortcut image file shown in FIG. 1;

FIG. 3 is a view showing an example of the image management method of the invention;

FIG. 4 is a view showing an example of the image management method of the invention;

FIG. 5 is a view showing a process environment capable of executing the invention and a structure of a client terminal;

FIG. 6 is a flow chart showing a control procedure for preparing a shortcut image in the invention;

FIG. 7 is a flow chart showing a control procedure for preparing an address tag in the invention;

FIG. 8 is a view showing an example of a transfer process in a partitionary management method for an image of the invention;

FIGS. 9A and 9B are views showing an example of a transfer process in the partitionary management method for an image of the invention;

FIGS. 10A and 10B are views showing an example of a transfer process in the partitionary management method for an image of the invention; and

FIG. 11 is a view showing an example of a transfer control procedure in the partitionary management method for an image of the invention.

### DETAILED DESCRIPTION OF THE PREFERRED EMBODIMENTS

In the following, a preferred embodiment of the present invention will be explained as an example, with reference to the accompanying drawings. However constituents described in the embodiment are mere examples and should not be construed as to limit the scope of the invention.

In the following there will be explained, as an example, a case of managing an image held in a client terminal such as a digital camera or a personal computer operated by a user.

### Embodiment 1

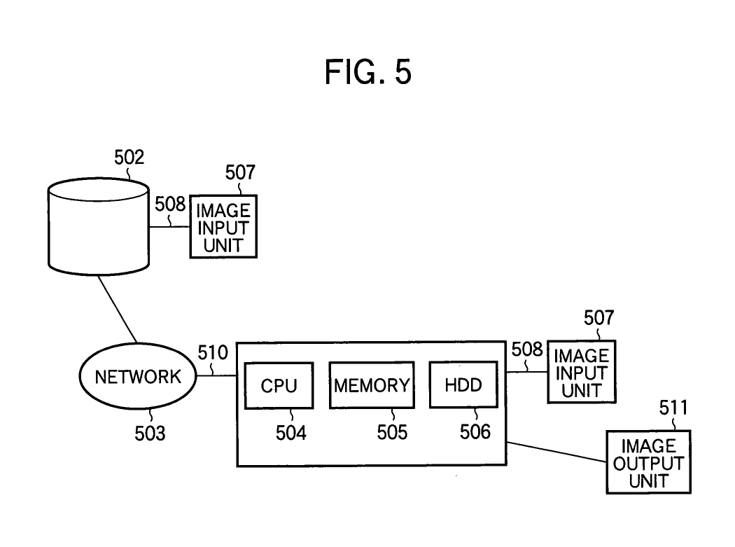

FIG. 5 illustrates a process environment in which an image management of the present embodiment is applicable. In FIG. 5, there is shown a client terminal 501, which is constituted specifically of a personal computer, a scanner or a digital camera.

In the following description, the client terminal 501 will be assumed as a personal computer, but the present embodiment is likewise applicable also in case it is a scanner or a digital camera.

The client terminal 501 is constituted of a CPU (central processing unit) 504, a memory 505, an HDD (hard disk drive) 506 and the like, and is arranged to be connectable to a network 503 through a network interface 710. On the network 503, there is provided a server 502 for providing, for example, an on-line photo album service. A hardware structure of the server 502 is not illustrated, but such server is constructed with hardwares similar to those of the client terminal 501, such as a CPU, a memory, an HDD and the like as in the client terminal 501.

In the present embodiment, an image to be managed is entered from image input means 507, connected by an interface 508 such as USB (universal serial bus), into the client terminal 501 or the server 502.

The client terminal 501 can output an image, obtained from the image input means 507 or downloaded from the server 502, through image output means 511 constituted of a display or a printer.

The present embodiment basically employs an image format in conformity with the DCF/Exif standard. In the following description, therefore, for indicating a specified portion of the image file, there will be used if necessary a term indicating a corresponding portion in the DCF/Exif (or JPEG) standard.

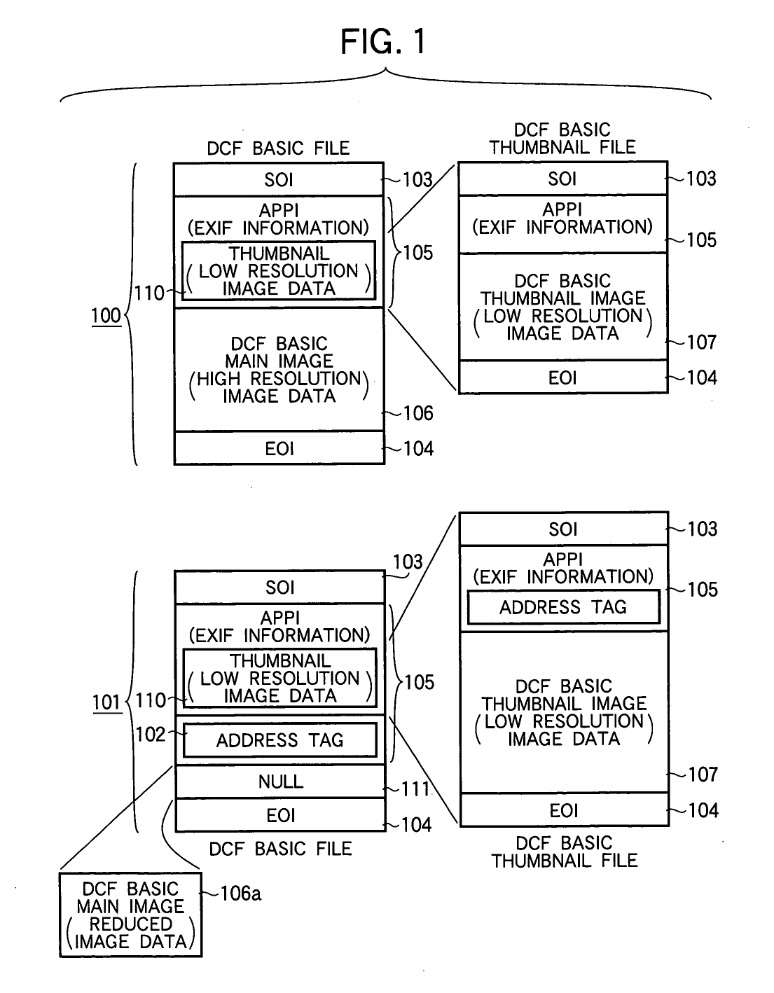

Now there will be explained, with reference to FIG. 1, formats of an original image file and a shortcut image file featuring the present invention.

In FIG. 1, 100 indicates a format of an original image file (upper part of FIG. 1). SOI (103, start of image) is a marker code (usually 0xFFD8) indicating the start of a compressed image data. EOI (105, end of image) is a marker code (usually 0xFFD9) indicating the end of a compressed image data. The DCF standard defines that the image data start with SOI and end with EOI.

An application marker segment APP1 stores addition information of main image data and a thumbnail image file which is image data of a lower resolution than that of the main image data. The APP1 has a marker of a value usually of 0xFFE1, and the APP1 data segment stores, after the marker, 2-byte size data and an actual data area. The addition information of the main image data can be, for example, photographing information of the image.

The original image data 106 of a high-resolution are stored, as shown in FIG. 1, as DCF basic main image, in succession to the APP1 data segment 105.

Also a thumbnail image file 110 is stored in the APP1 data segment 105. Also the thumbnail image file 110 starts with SOI and ends with EOI. Thumbnail image data 107 are stored, as shown in FIG. 1, as a DCF basic main image, in the thumbnail image file 110. Thus the thumbnail image file 110 itself is described in conformity with the DCF standard. An APP1 data segment 105 of the thumbnail image file 110 may have a content same as that of the APP1 data segment 105 of the DCF basic file.

Thus the original image file in conformity with the DCF standard includes, as shown in the upper part of FIG. 1, the thumbnail image data 107 of a low-resolution and the original image data 106 of a high-resolution, so that the thumbnail image data 107 or the original image data 106 may be accessed respectively when a summary or details of the image are required. The thumbnail image data 107 are used, for example in a digital camera, for a thumbnail display by a display device such as LCD (liquid crystal display).

In a lower part of FIG. 1, there is shown a format of a shortcut image file 101, which is constituted, as in the original image file, of a DCF basic format. The shortcut image file 110 includes the thumbnail image data as in the original image file, but does not include, as a first feature, the original image data of a high-resolution as a DCF basic main image in the original image file. In the present embodiment, NULL data 111 are stored in a position where the DCF basic main image is to be stored in the DCF standard. Nevertheless, the shortcut image file 101, in case a large data size is permissible, may also include original image data of a high-resolution as a DCF basic main image.

Otherwise, as shown in a lower left portion of FIG. 1, reduced image data 106a generated by reducing the original image data 106 of high-resolution, stored as the DCF basic main image in the original image file 100, may be stored instead of the NULL data 111. Such reduced image data 106a preferably have a data size larger than that of the thumbnail image data employed in the DCF/Exif standards. In the thumbnail image data employed in the DCF/Exif standards, as generated with a very high-reduction ratio in order to display many thumbnail images in a limited display area such as an LCD display of a digital camera, it may be difficult to observe details of an image. Thus, reduced image data 106a generated with a reduction ratio smaller than that in the thumbnail image data employed in the DCF/Exif standards allow the user to sufficiently observe the details of the image, and still the shortcut image file can have a file size smaller than that of the original image file, by utilizing the reduced image data 106a instead of the original image data 106 of the high-resolution.

Also the shortcut image file 101 of the present embodiment has, as a second feature, address tags 102 indicating a storage location of the original image file 100, in the respective APP1 areas of the DCF basic file of the shortcut image file 101 and of the DCF basic thumbnail file.

Therefore, the shortcut image file 101 shown in FIG. 1 can be generated from the original image file 100, by eliminating the original image data 106 of the high-resolution stored as the DCF basic main image, storing the NULL data 111 instead, and attaching the address tag 102 indicating the storage location of the original image file 100. It can also be generated by reducing the original image data of the high-resolution, stored as the DCF basic main image in the original image file 100, thereby generating reduced image data 106a, eliminating the original image data 106 of the high-resolution, stored as the DCF basic main image, from the original image file 100 and storing the reduced image data 106a instead, and attaching attaching the address tag 102 indicating the storage location of the original image file 100. The address tag 102 is described, for example as explained later, by a URL (or URI) format.

The present embodiment records, as explained above, an image in partitionary manner utilizing an original image file 100 and a shortcut image file having a format in conformity with the DCF standard.

In the present embodiment, as the shortcut image file 101 includes the address tag 102 indicating the storage location of the original image file 100, the original image file 100 can be acquired by such shortcut image file 101. For example in case the user receives the shortcut image file 101 by an e-mail, such shortcut image file 101 allows to obtain the original image 100 by the address tag 102 therein, even if the main text of the e-mail is absent.

In the present embodiment, the shortcut image file 101 may be present in plural units for a single original image file 100.

In the present embodiment, an image file containing an address tag is identified as the shortcut image file 101, but an exclusive tag for indicating whether or not an image file is a shortcut image file 101 may also be defined. Also the original image file 100 having the original image data of the high-resolution as a DCF basic main image may contain an address tag.

Furthermore, the shortcut image file 101 may contain the original image data of the high-resolution as a DCF basic main image, though the file size becomes larger.

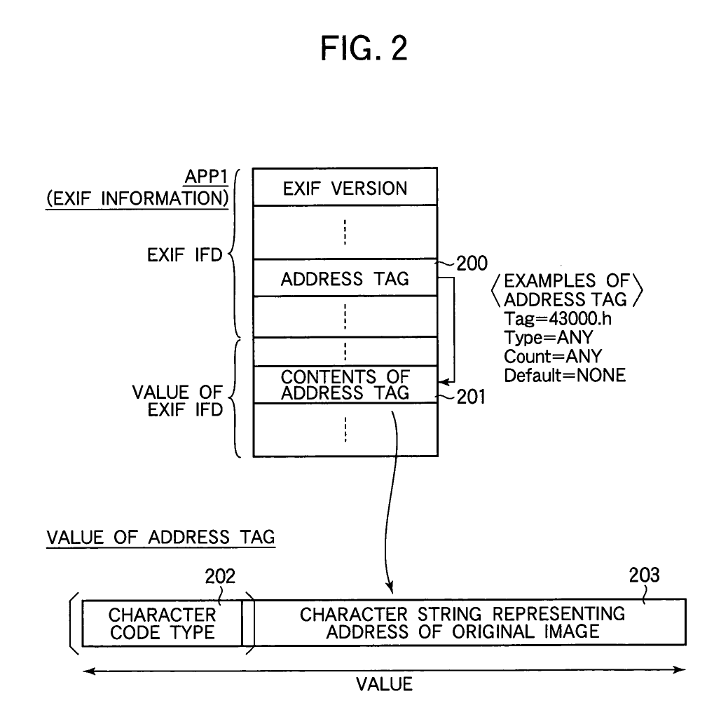

In the following there will be explained, with reference to FIG. 2, a data structure of the address tag attached to the shortcut image 102.

The address tag is recorded, as indicated by 200, in ExifIFD in conformity with the Exif(DCF) standard. For a tag number, the address tag utilizes a Tiff private tag number (for example 43000 in the present embodiment).

A tag Value, indicating the content of the address tag, is recorded in Value of ExifIFD. A storage location of the Value is recorded in a ValueOffset of the address tag. The address tag is not particularly restricted in Tag, Type, Count and ValueOffset, and the Type can be set for example as “ANY” and the Count can be set as Any.

The Value 201 of the address tag has a following content. As shown in FIG. 2, at the head of the Value of the address tag, a character code type information 202 for identifying a subsequent character code is recorded. The character code type information 202 designates for example an ASCH code, a JIS code, a Unicode or another character code.

Subsequent to the character code type information 202, there is recorded a character string 203 indicating the storage location of the original image file 100 as a Value 201. The address character string is constituted of a path name indicating the storage location of the original image file 100 and a file name thereof. An offset to the Value of the address tag is recorded in the ValueOffset of the address tag according to the TIFF rules.

Also the Value 201 of the address tag may omit the character code type information 202 but may only record the character string 201 indicating the address of the original image file 100.

For example, in case a fixed character code, such as UTF-8, is always used, the character code type information is unnecessary, but in case of encoding with UTF-16, the Value has to be started with a byte order mark (ZERO WIDTH NO-BREAK SPACE characters 0xFEFF or 0xFFFE) defined in the ISO/IEC 10646, annex and in the Unicode annex B. Also an identification code (0xEF, 0xBB or 0xBF) may be placed in the first three bytes in order to explicitly indicate the UTF-8.

Also the Value 201 of the address tag may be recorded according to UDF. In this case, the Value records a character code type in the first byte, then a character string length in a next byte and then an address character string indicating the storage location of the original image file 100.

In the present embodiment, as explained in the foregoing, a client terminal 501 or a communication device, provided with an arbitrary application software capable of accessing to the shortcut image file 101 can know the storage location of the original image file 100 by referring to the address tag 200 through the shortcut image file 101. Then such client terminal 501 or the communication device can acquire the original image data of the high-resolution in the original image file 100 in conformity with such address tag 200.

Thus the present embodiment realizes an image management method in which an original image file of a larger file size and a shortcut image file of a smaller file size in separate storage locations.

It is thus conceivable, in case a summary of the image is enough, to utilize the shortcut image file 101 of the smaller file size that does not cause much occupation of an image storing memory area, and to utilize the original image file 100, in case details of the image are required.

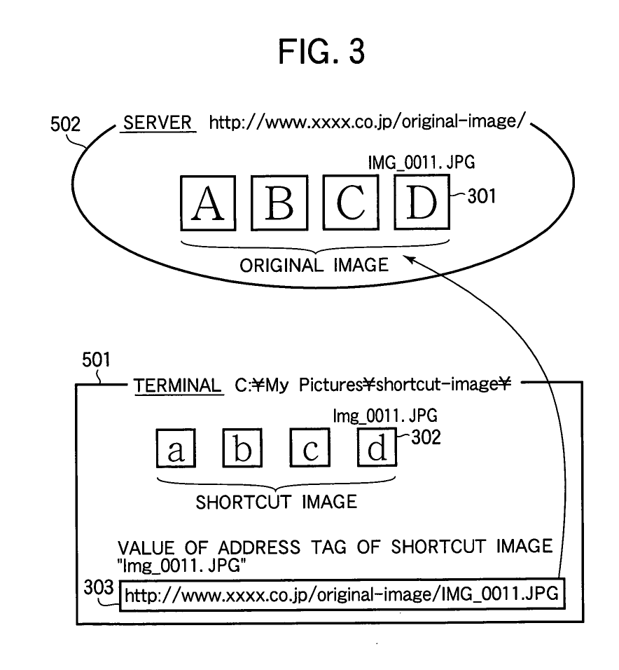

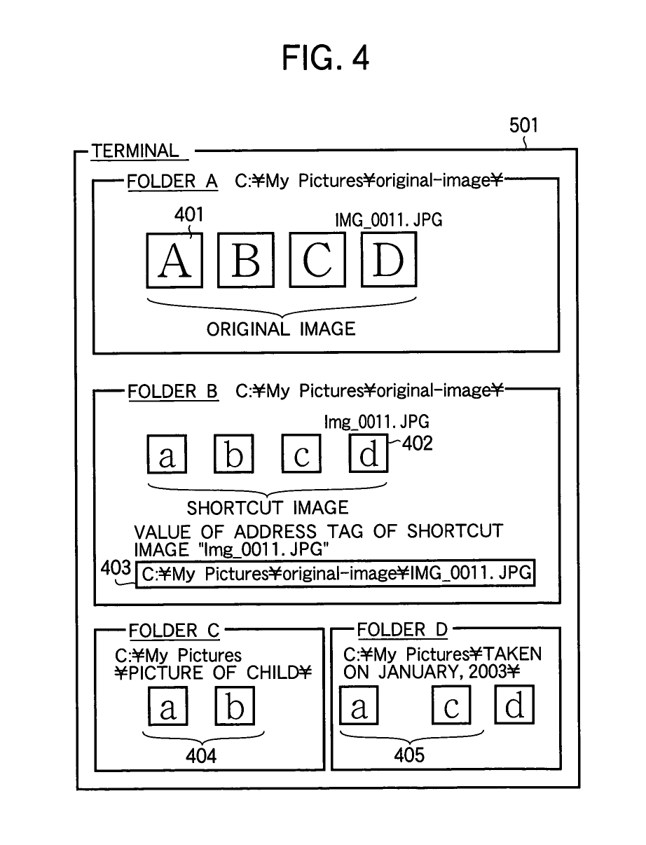

In the following there will be explained, with reference to FIGS. 3 and 4, an example of image management employing the original image file 100 and the shortcut image file 101 of the present embodiment.

FIG. 3 shows a state where the original image file 100 is stored in a predetermined address, for example “http://www.xxxx.co.jp/original-image/” on the server 502, and shortcut image files (for example a, b, c and d) 302 corresponding to the original image files (for example A, B, C and D) are stored in a predetermined storage location, for example “C:¥MyPictures¥shortcut-image¥” in the client terminal 501.

Referring to FIG. 3, in which an original image file “D” of a file name “IMG_{—}0011.JPG” indicated by 301 corresponds to a shortcut image file “d” of a file name “img_{—}0011.JPG” indicated by 302, as the original image file “D” has a storage location “http://www.xxxx.co.jp/original-image/” and a file name “IMG_{—}0011.JPG”, the address tag of the shortcut image “d” records “http://www.xxxx.co.jp/original-image/IMG_{—}0011.JPG” as indicated by 303.

For example, when the user stores an original image file 301 of a photograph image taken by a digital camera in the server 502 provided by an on-line photo album service or the like and also stores a shortcut image file 302 corresponding to the original image file 301 in the client terminal 501 operated by the user (for example by a transmission of the shortcut image file 302 in an attachment to an e-mail from the server 502 to the client terminal 501), the user can know, even without connecting the client terminal 501 to the server 502, a summary of the original image file 301 stored in the server 502 by accessing to the thumbnail image data of the shortcut image file 302 stored for example in the HDD 506 of the client terminal 501.

Also in case the client terminal 501 has a restricted memory area such as a PDA or a portable terminal, the shortcut image file 302 of a small file size allows to know the rough content of the original image file 301 of a large file size. Thus the user, only in case of wishing to know the details of the original image file 301, can connect the client terminal 501 to the server 502 and can acquire the original image file 301.

Also by storing the original image file 301 in the server 502, any terminal connectible to the server 502 and having the shortcut image file 302 can obtain the original image file 301 and know the details thereof. Consequently, in case of exchanging images among the users, the shortcut image file 302 alone can be used for this purpose.

For example, in case of transmitting a photograph image by an e-mail, a shortcut image file 302 thereof can be attached to reduce the file size of the e-mail, and the user having received the shortcut image file 302 can obtain, when necessary, the original image 301 stored in the server 502, utilizing such shortcut image file 302.

For transferring the image to the receiving user with an e-mail of a small file size, there is known a method described in the aforementioned U.S. Pat. No. 6,101,526 in which the image is obtained according to a link described in the e-mail, but, in the method of the present embodiment, the receiving user is not required to access to the main text of the e-mail for obtaining the image, since the shortcut image file 302 contains the storage location of the original image file 301.

Also the shortcut image file 302 can be utilized in communication means other than the e-mail for reducing the restriction in the file size and enabling an exchange of image with another user. For example a memory card storing the shortcut image file 302 alone may be delivered to another user, who can then acquire the original image file 301 in conformity with the shortcut image file 302 stored in such memory card.

FIG. 3 shows a state where the original image file 301 and the shortcut image file 302 are respectively stored in different hosts (namely server 502 and client terminal 501), but the management method of the present embodiment can be utilized also in a case where the original image file 301 and the shortcut image file 302 are stored in different folders (directories) of a same host (server 502 or client terminal 501) as shown in FIG. 4.

FIG. 4 shows a case where an original image file 401 is stored in a folder A “C:¥My Pictures¥original-image¥” and shortcut image files (for example a, b, c and d) 402 corresponding to the original image files (for example A, B, C and D) 401 are stored in another folder B “C:¥My Pictures¥shortcut-images¥”, a folder C “C¥My Pictures¥Picture of Child¥” and a folder D″C:¥My Pictures¥Taken on January 2003¥” in a same client terminal 401. These folders (directories) are prepared, for example in a structure shown in FIG. 5, in the HDD 506 of the client terminal 501.

Referring to FIG. 4, in which an original image file “D” of a file name “IMG_{—}0011.JPG” indicated by 402 corresponds to a shortcut image file “d” of a file name “img_{—}0011.JPG” indicated by 403, as the original image file “D” has a storage location “C:¥My Pictures¥original-image¥” and a file name “IMG_{—}0011.JPG”, the address tag of the shortcut image “d” records ““C:¥My Pictures¥original-image¥IMG_{—}0011.JPG” as indicated by 403.

In a management form as shown in FIG. 4, in which, for example, the user stores an original image file 401 of a photograph image taken by a digital camera in an arbitrary folder of the client terminal 501 of the user and a shortcut image file 402 corresponding to the original image file 401 in another folder, the user can achieve a classified storage of the images for example by storing the original image files collectively in a specified folder and storing the shortcut images 402 in plural folders partitioned for example with respect to a phototaking time or by a subject.

As the shortcut image file 402 may be prepared in plural units for a single original image file 401, in case the original image file 401 “A” is for example taken on January 2003 and contains a child as the subject, shortcut image files 404, 405 “a” may be contained respectively in a folder C for a child as the subject and a folder D for a phototaking time in January 2003.

Plural shortcut image files 402 are permitted for a single original image file 401 for the following reason.

In an image management for example in a personal computer, there may arise a requirement for a management under different categories such as “an image containing a child as a subject” and “an image taken in January 2003” for a single image file. In such situation, in case same image files are copied in a folder “child as subject” and a folder “taken on January 2003”, the memory area becomes tight because of large sizes of such files. For this reason, there has been employed a method of storing the image file in a specified location and managing the image file by a shortcut file thereof (for example “Shortcut” of Windows (trade name)), but, in such method utilizing the shortcut file, the summary of the image can be only known through a system file of the operating system and cannot be known easily from the shortcut file depending on the image-managing application. Also in case of utilizing the system file, it becomes large in size with an increase in the number of the managed image files. Such difficulty in the file size can be prevented by erasing unused reduced images from the system file at an arbitrary timing, but an image processing is required in each renewal of the system file.

On the other hand, in the management system of the present embodiment shown in FIG. 4, shortcut image files 402, 404, 405, being smaller in the file size than the original image file 401, can suppress an increase in the file size even when such shortcut image files 402, 404, 405 related with a same original image file 401 are present in plural categories. Also the system file of the operating system need not be used as the shortcut image files 402, 404, 405 are independent.

As explained in the foregoing, the present embodiment allows an efficient management by image classification into the different categories, utilizing the shortcut image file 101.

In the following there will be explained, with reference to FIGS. 5 to 7, in the management form where the original image file 301 is stored in the server 502 and the shortcut image file 302 is stored in the client terminal 501, a procedure of preparing the shortcut image file 302 from the original image file 301 in the server 502. As an example, there will be considered a case of preparing a shortcut image file 302 of a file name “img_{—}0011.JPG” from an original image file 301 of a file name “IMG_{—}0011.JPG” stored in a location “http://www.xxxx.co.jp/original-image/” in the server 502. In the configuration shown in FIG. 5, the original image file 301 is assumed to entered into the server 502 from image input means 507 through the interface 508. Otherwise, the original image file 301 may be entered into the client terminal 501 from the image input means 507 and then supplied to the server 502 through the network 503 and the interface 508.

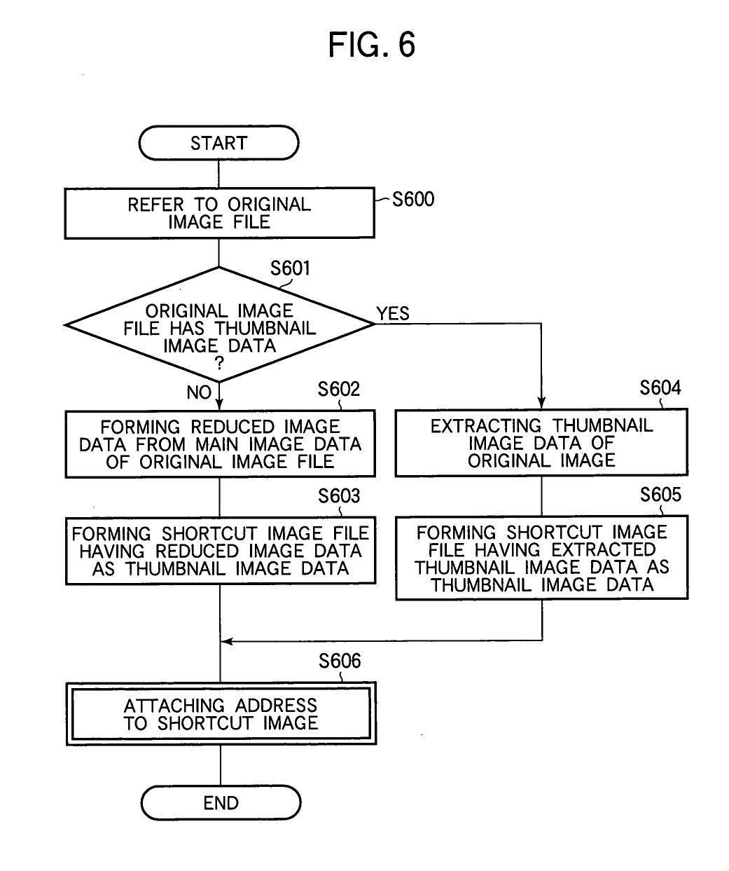

FIG. 6 is a flow chart showing a control sequence of preparing a shortcut image file 302 from an original image file 301 stored in an arbitrary location. In the following there will be explained a case where the procedure is executed by the server 502, but the control sequence in FIG. 6 may also be executed by the client terminal 501. An entity executing the control sequence in FIG. 6 is a CPU (504) of the client terminal 501 or the server 502, and the sequence in FIG. 6 may be stored as a control program for the CPU (504) in an HDD (506) or a memory (505). A program corresponding to the control sequence in FIG. 6 may be supplied in an arbitrary path, and may be stored in such memory media at the time of the product shipment or may be supplied with a memory medium such as an MO, a CD-ROM or a DVD-ROM, or through a network.

In a step S600 in FIG. 6, the server 502 accesses to the original image file 301 “IMG_{—}0011.JPG” constituting a subject of a shortcut image file 302 to be prepared. The original image file 301 “IMG_{—}0011.JPG” contains, in an image file taken with the digital camera and in conformity with the DCF standard, at least a portion of the DCF basic main image 106 (FIG. 1), and may further contain thumbnail image data 107.

The access of the server 502 to the original image file 301 in the step S600 is made in order to obtain the thumbnail image data 107 (FIG. 1) or the original image data 106 (FIG. 1) in a step S602 or S604.

In case the control sequence in FIG. 6 is executed by the client terminal 501, the original image file 301 may be stored in any location. More specifically, as long as the original image file 301 is stored in the server 502 after the preparation of the shortcut image file 302 by the client terminal 501, the original image file 301 need not necessarily be stored in the server 502 at the preparation of the shortcut image file 302.

Then, in a step S601, the server 502 discriminates whether the original image file 301 “IMG_{—}0011.JPG” contains the thumbnail image data 107 (FIG. 1). In case the original image file 301 is identified to contain the thumbnail image data 107 (FIG. 1), the server 502 extracts, in a step S604, the thumbnail image data 107 (FIG. 1) from the original image file 301. Then, in a step S605, the server 502 stores the thumbnail image data 107 (FIG. 1) as a DCF basic thumbnail image, thereby preparing the shortcut image file 302 “img_{—}0011.JPG”.

On the other hand, in case the original image file 301 is identified not to contain the thumbnail image data 107 (FIG. 1), the server 502 executes, in a step S602, an arbitrary skipping on the original image data 106 (FIG. 1) of the high-resolution, stored as a DCF basic main image of the original image data, thereby generating reduced image data 106a (FIG. 1). Then, in a step S603, the server 502 stores the reduced image data 106a (FIG. 1) as a DCF basic thumbnail image, thereby preparing the shortcut image file 302 “img_{—}0011.JPG”.

Through the aforementioned process, there is generated a shortcut image file 302, which stores, as a DCF basic thumbnail image, the thumbnail image data 107 (FIG. 1) of the original image file 301 or the thumbnail image data 107 (FIG. 1) generated by reducing the original image data stored as a DCF basic main image of the original image file 301.

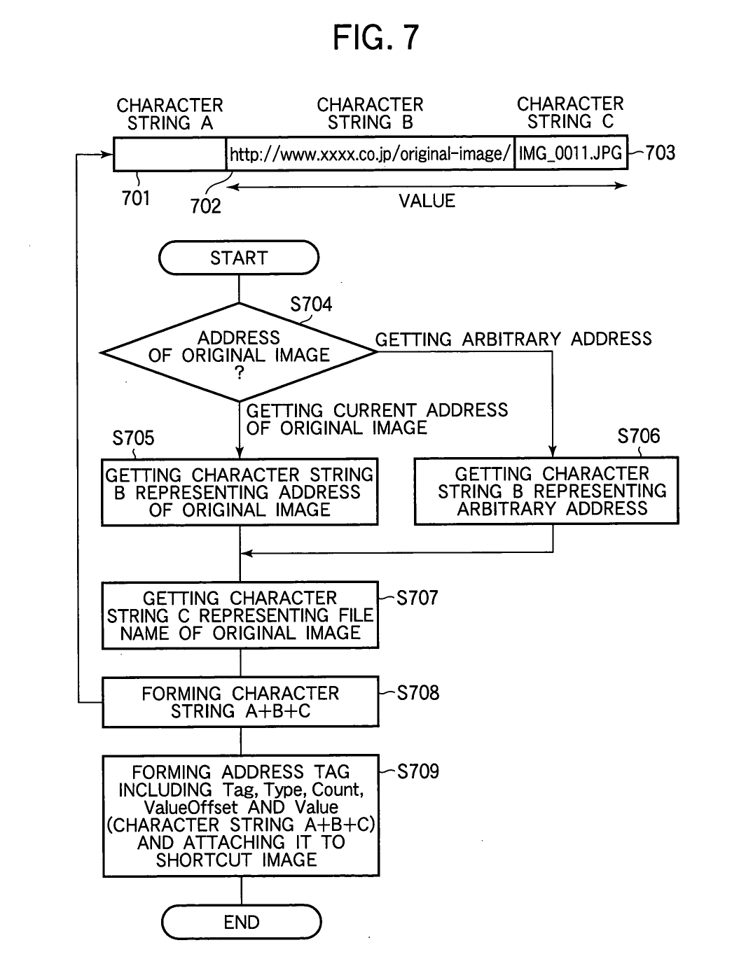

Then, in a step S606, the server 502 generates an address tag indicating a storage location or a final storage location of the original image file 301 accessed in the step S600, and attaches it to the shortcut image file 302. A procedure of preparation of the address tag attached to the shortcut image file 302 in the step S606 will be explained later with reference to FIG. 7.

Then, in a step S607, the server 502 stores NULL data 111 (FIG. 1) as a DCF basic main image of the shortcut image file 302. Otherwise, the server 502 reduces the original image data 106 (FIG. 1) of the original image file 301 to generate reduced image data 106a and stores it as a DCF basic main image of the shortcut image file 302. The reduced image data 106a preferably have a data size smaller than that of the original image data 106 (FIG. 1) and larger than that of the thumbnail image data 107 (FIG. 1). Otherwise, if a large file size is permissible in the shortcut image file 302, the original image data 106 (FIG. 1) of the original image file 301 are stored as the DCF basic main image.

Also the server 502 copies the photographing information, stored in the original image file 301, in the APP1 data segment 501 of the shortcut image file 302.

In this manner, the shortcut image file 302 is prepared in the server 502.

Then the server 502 transmits the thumbnail image file 302 to the client terminal 501 or an arbitrary communication device through the network 503.

In case the control sequence in FIG. 6 is executed by the client terminal 501, there is also executed a step that the client terminal 501 transfer the original image file 301 to the server 502. The server 502 stores the transferred original image file 301 in the HDD 506 thereof. Further, the client terminal 501 may transfer also the prepared shortcut image file 302 to the server 502 for storage in the HDD 506 thereof. Then, upon confirming that the storage of the original image file 301 in the HDD 506 of the server 502, the client terminal 501 may erase the original image file 301 from the HDD 506 of the client terminal 501. In this manner, the burden of the HDD 506 of the client terminal 501 can be alleviated.

In the present embodiment, the shortcut image file 302 is prepared from an already existent original image file 301, but the thumbnail image file 302 may be similarly generated at a new generation of the original image file 301. For example, when a digital camera as the image input means 507 (FIG. 5) acquires a photograph image, the shortcut image file 302 may be prepared together with the original image file 301 in conformity with such photograph image.

In the following, there will be explained, with reference to FIG. 7, a preparation procedure of the address tag 102 (FIG. 1) in the step S606 of the control sequence shown in FIG. 6.

The address tag 102 (FIG. 1) to be attached to the thumbnail image file 302 is constituted of a path name 702 (character string B) indicating the storage location of the original image file 301, a file name 703 (character string C) of the original image file 302, and a character code type 701 (character string A) indicating a character code of the character strings B, C. The character code type information (character string A) may be dispensed with as explained before.

Referring to FIG. 7, at first in a step S704, the server 502 discriminates how the storage location of the original image file 302 is determined. More specifically, it discriminates whether the storage location is determined by a storage location of the original image file 301 at the preparation of the shortcut image file 302 or by a final storage location of the original image data 301.

In case the step S704 identifies the determination by the storage location of the original image file 301 at the preparation of the shortcut image, the server 502 acquires, in a step S705, the storage location of the original image file as a character string B.

On the other hand, in case the step S704 identifies the determination by the final storage location of the original image file 301, the server 502 acquires, in a step S706, a character string indicating an arbitrarily entered storage location as a character string B.

Such arbitrarily entered storage location may be entered by the user of the server 502 through a specified user interface, or an arbitrary storage location entered by the user of the client terminal 501 may be received through the network 503. Also it may be set according to the specification of an application software or the server 502 for preparing the shortcut image file 302. For example, in the present embodiment, it is set in the application software or the server 502 for preparing the thumbnail image file to always store the original image file 301 at “http://www.xxxx.co.jp/original-image/” in the server 502, and, in such case, a step S706 acquires “http://www.xxxx.co.jp/original-image/” as a character string B.

After the character string B is acquired in the step S705 or S706, the server 502 in a next step S707 acquires a character string C indicating the file name of the original image file 301. In the present embodiment, the file name “IMG_{—}0011.JPG” of the original image file 301 is acquired as a character string C.

Then, in a step S708, the server 502 combines the character strings A, B and C to prepare an address character string of the original image file 301. In this operation, the character string A indicating the character code type of the character strings B and C may be dispensed with. In the present embodiment, as the character strings B and C are described and encoded by UTF-8, the character string A is not used.

Then, in a step S709, the server 502 prepares an address tag 102 (FIG. 1) having a Value of the address character string prepared in the step S708, and attaches the address tag to the shortcut image file 302. In the present embodiment, an address tag having a Value “http://www.xxxx.co.jp/original-image/IMG_{—}0011.JPG” is attached to the shortcut image file 302 “img_{—}0011.JPG”.

Through the aforementioned control sequence there can be prepared the shortcut image file 302 “img_{—}0011.JPG”, corresponding to the original image file 301 of the file name “IMG_{—}0011.JPG” stored in “http://www.xxxx.co.jp/original-image” of the server 502. As the address tag 102 (FIG. 1) of the shortcut image file 302 “img_{—}0011.JPG” records the storage address “http://www.xxxx.co.jp/original-image/IMG_{—}0011.JPG” of the original image file 301, the client terminal 501 or the communication device equipped with an application software capable of access to the shortcut image file 301 can make an access to the original image file 301 when necessary.

Means or a procedure, for acquiring the original image file 301 by the application software of the client terminal 501 or the communication device accessible to the shortcut image file 302 utilizing the address tag 102 (FIG. 1) of the original image file 301 attached to the shortcut image file 302, can be arbitrarily provided by those skilled in the art. For example, the application software is only required to extract the address tag 102 (FIG. 1) stored in the shortcut image file 302 and to download, copy or read the original image file 301 through an arbitrary interface. Also the extraction of the address tag 102 (FIG. 1) by the application software can be achieved, since the address tag 102 (FIG. 1) is stored as the APP1 data of the thumbnail image file 302 in conformity with the DCF/Exif standard, for example by recognizing the tag number of the address tag 102 (FIG. 1) and extracting the content thereof. Consequently an existing application software can extract, without a major change in the specification thereof, the address tag 102 (FIG. 1) from the shortcut image file 302.

Also in the present embodiment, as the address tag 102 (FIG. 1) is stored in an URL (URI) format, it can represent the storage location of the original image file 301 not only in the server 502 but also in a local folder and a very flexible application is possible. Also as the URL (URI) format can also designate an access method, the original image file 301 can be made available to the client terminal 501 or the communication device through various access methods (in the foregoing, there is shown an example in which the original image is accessed through HTTP, but the URL (URI) format can naturally designate FTP or other access methods).

Also in the present embodiment, in case thumbnail data 107 are already stored in the original image file 301 as APP1 data of DCF/Exif standard employed in the digital camera or the like, such data are utilized as the thumbnail image data 107 to be stored in the shortcut image file 302, so that the shortcut image file 302 can be generated at a high speed with a low calculation cost.

In the present embodiment, in case of storing the reduced image data 106a as the DCF basic main image of the shortcut image file, the original image data 106 are downloaded by referring to the extracted address tag 102, so that, even in case the original image data 106 that should have been stored in the server 502 are erased, the reduced image data 106a of a data size larger than that of the thumbnail image data 107 in the shortcut image file 302 may be utilized by the user instead of the original image data 106. By selecting the reduction ratio of the reduced image data 106a smaller than the reduction ratio, in the DCF/Exif format, of the thumbnail image data 107, it is possible to increase the possibility of meeting the desire of the user for image utilization even when the original image data 106 are erased. Also the thumbnail image data 107 employed in the DCF/Exif format may be too small for observing the details of the image in a portable terminal or the like having a display of a relatively large size, but such reduced image data 106a can be effectively utilized also in a display of a large size.

Also in the invention, the server 502, the client terminal 501 or the communication device can instruct an erasure of the stored original image file 100, in conformity with the address tag 102 of the shortcut image file 101.

Also in contrast to the shortcut, the alias or the symbolic link, the present embodiment utilizes an image file, in conformity with the DCF/Exif format and usable as an image file by itself, so that any ordinary application software capable of handling an image file of JPEG standard (such as an image viewer or a WEB browser) can display the shortcut image file or edit the shortcut image file, if necessary.

As explained in the foregoing, the present embodiment is characterized in managing an image by using an original image file containing original image data of a high-resolution, and a shortcut image file which contains thumbnail image data of a lower resolution than that of the original image data and to which an address tag indicating a storage location of the original image file is attached.

According to the present embodiment, the user can utilize only the image data stored in the shortcut image file of a smaller file size in case of knowing a summary of the image, and, in case of knowing details of the image, can utilize the original image data of a high-resolution in the original image file, solely by way of the shortcut image file.

Also according to the present embodiment, since the shortcut image file itself contains the storage location of the original image file as the address tag, the user can access to the original image file by way of the shortcut image file even if a main text of a mail or the like, to which the second image file is attached, is lost.

Also according to the present embodiment, the original image file and the shortcut image file can be stored in partitionary manner in respectively different locations. For example, the original image file and the shortcut image file can be managed by different hosts, such as a client terminal and a server on a network, or by different folders of a file system of the client terminal.

Thus, the present embodiment enables secure separate managements of image data of a higher resolution and image data of a lower resolution while maintaining a correlation therebetween, with a simple and inexpensive configuration.

### Embodiment 2

In the following, there will be explained a method of transferring the image data of the original image file 100 or the shortcut image file 101, in conformity with the shortcut image having the aforementioned file format.

The present embodiment will be explained by a case where, as shown in FIG. 3, a shortcut image file 302 “a” is stored in the client terminal 501 and an original image file 301 “A” is stored in the server 502. Also in the following description, there will be explained a case where the client terminal 501 acquires, in conformity with the shortcut image file 302, the image data of the original image file 100 or the image data of the shortcut image file 101 from the server 502. Also the present embodiment is applicable to a process environment similar to that of the first embodiment, and parts common to both examples will not be explained in repetition.

The present embodiment is applicable also to a case where the shortcut image file 302 “a” is stored in the server. 502 and the original image file 301 “A” is stored in the client terminal 501, and the server 502 acquires, in conformity with the shortcut image file 302, the image data of the original image file 100 or the image data of the shortcut image file 101 from the client terminal 501.

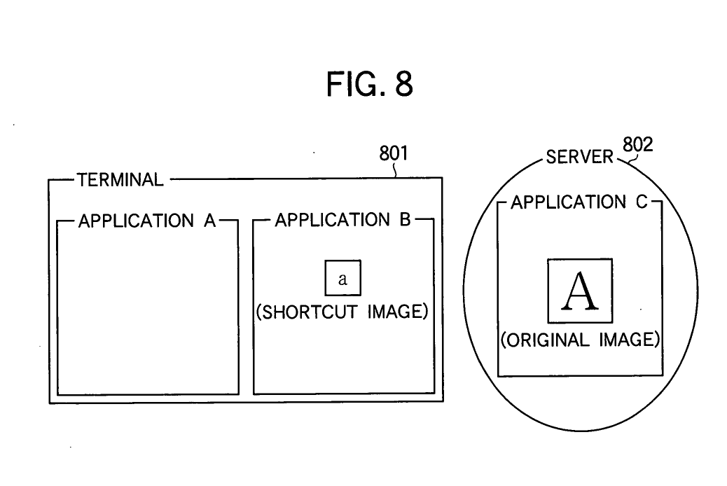

FIGS. 8 to 10B shows an example of the image transfer procedure in the invention.

FIG. 8 shows a software structure of the client terminal 501 and the server 502, in which applications A and B function on the client terminal 501 while an application C functions on the server 502.

In the present embodiment, these applications A to C are not particularly specified, but it is assumed that the application A is used by the user for an image control such as an image browsing or a print instruction thereof, the application B manages the shortcut image file 302 “a” stored in the client terminal 501, and the application C manages the original image file 301 “A” stored in the server 502 and corresponding to the shortcut image file 302 “a”.

Naturally the shortcut image file 302 “a” and the original image file 301 “A” are mutually correlated by structures explained in FIGS. 1 to 4.

In the present embodiment, the application A functioning on the client terminal 501 acquires the thumbnail image data 107 of the shortcut image file 302 “a” or the original image data of the original image file 301 “A” from the application B or C.

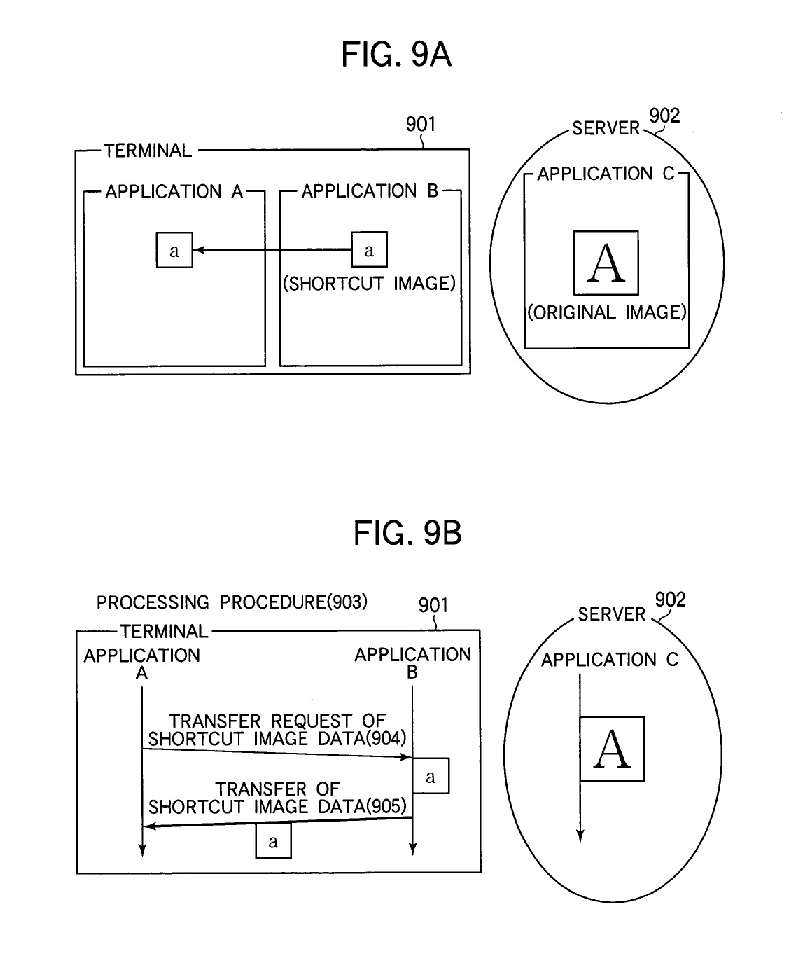

FIG. 9A shows a procedure in which the application A acquires the thumbnail image data 107 of the shortcut image file 302 “a” on the client terminal 501, and FIG. 9B shows a transfer sequence for the shortcut image file 302 “a” in the applications A and B.

This corresponds to a case where the application A of the client terminal 501 tries to acquire the thumbnail image data 107 of the thumbnail image file 302 “a” which is under the management of the application B.

In such case, as indicated in a transfer procedure (903) for the shortcut image file, the application A transmits a transfer request for the shortcut image file to the application B on the client terminal 501 (S904). In response to such request, the application B on the client terminal 501 extracts the thumbnail image data 107 from the thumbnail image file 302 “a” and transfers it to the application A (S905). Details of the transfer procedure will be explained later.

The transfer operation of FIGS. 9A and 9B is executed, for example, when the user who operates the application A with the client terminal 501 wishes to know only the summary of the original image file 301 “A”. More specifically, in case the application A on the client terminal 501 is a browser and the application B is an OS functioning on the client terminal 501, FIGS. 9A and 9B show an operation executed when the user browses, utilizing such browser, the shortcut image file 302 “a” stored in the HDD 506 of a personal computer constituting the client terminal 501.

In such situation, the thumbnail image data 107 of the shortcut image file 302 “a” displayed by the browser are in conformity with the DCF standard. As the thumbnail image data 107 are smaller in data size than the original image data 106, the client terminal 501 has a reduced burden on the memory in comparison with a process in which the browser develops and displays the original image data 106. Particularly in case the user wishes to know only the summaries of plural images, the reduction in the burden on the memory of the client terminal 501 becomes more conspicuous as the difference becomes greater between the total data sizes of the plural original image data 106 and the total data sizes of the plural thumbnail image data 107.

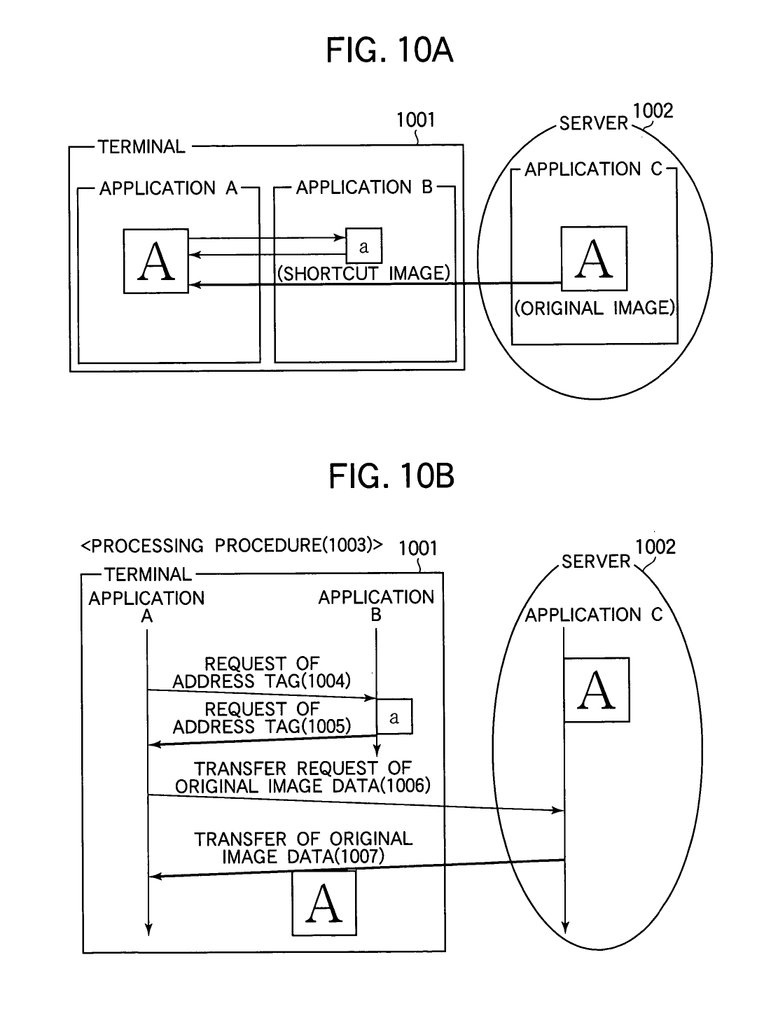

FIG. 10A shows a procedure in which the application A of the client terminal 501 acquires the original image data 106 of the original image file 301 “A” under the management of the application C in the server 502. Also FIG. 10B shows an address tag information transfer sequence for the shortcut image file 302 by the applications A and B, and a transfer sequence for the original image file 301 by the application A of the client terminal 501 and the application C of the server 502.

This corresponds to a case where the application A of the client terminal 501 tries to acquire the original image data 106 of a higher resolution than in the thumbnail image data 107 of the thumbnail image file 302 “a”, from the original image file 301 “A” under the management of the application C of the server 502. At first the application A of the client terminal 501 acquires the address tag 102 of the shortcut image file 302 “a” under the management of the application B. Then the application A of the client terminal 501 acquires, in conformity with such address tag 102, the original image data 106 of the original image file 301 “A” under the management of the application C of the server 502.

FIG. 10B shows a transfer sequence for the shortcut image file 302 shown in FIG. 10A. On the client terminal 501, the application A transmits an address tag acquisition request to the application B (S104). Then, on the client terminal 501, the application B transfers the address tag 102 of the shortcut image file 302 “a” to the application A (S1005). Subsequently, the application A of the client terminal 501 analyzes the acquired address tag and, according to the storage location described in the address tag 102, an original image data acquisition request for the original image file 301 “A” to the application C of the server 502 (S1006). In response to such request, the application C of the server 502 transfers the original image data 106 of the original image file 301 “A” to the application A of the client terminal 501 (S1007). Details of this procedure will be explained later.

The processes of FIGS. 10A and 10B are executed, for example, when the user who operates the application A with the client terminal 501 wishes to know the details of the image shown in the shortcut image file 302 “a”.

For example in case the terminal 501 is a personal computer, the application A is a browser and the application B is an OS functioning on the client terminal 501 as shown in FIGS. 9A and 9B, there can be executed operations of browsing the shortcut image file 302 “a” by the browser displayed on a display of image output means 511 and printing the shortcut image file 302 “a” by a printer of the image output means 511. In the procedures in FIGS. 10A and 10B, when the user browses the shortcut image file 302 “a” by the browser and instructs a printing of such image, the original image data 106 are transferred in order to execute the printing by the original image data 106, contained in the original image file 301 “A”, of a higher resolution than in the thumbnail image data 107 of a lower resolution contained in the shortcut image file 302 “a”, thereby improving the print quality.

Stated differently, the procedures shown in FIGS. 9A and 9B allow the user to browse the shortcut image file 302 “a”. Then, in case a printing or the like is required, the original image data 106 are acquired and printed as shown in FIGS. 10A and 10B by accessing to the original image file 301 “A” utilizing the address tag recorded in the shortcut image file 302 “a”.

In the foregoing description, the applications A, B and C have different functions, but the present embodiment does not particularly specify the functions of the image managing applications. For example it is also possible that an application A, accessible to both the client terminal 501 and the server 502 and including the functions of the applications B and C, makes a direct access to the shortcut image file 302 “a” and the original image file 301 “A” thereby acquiring various image data. Also the client terminal 501 and the server 502 need not be classified as explained above, and a similar process may be executed between the client terminals 501 or between the servers 502.

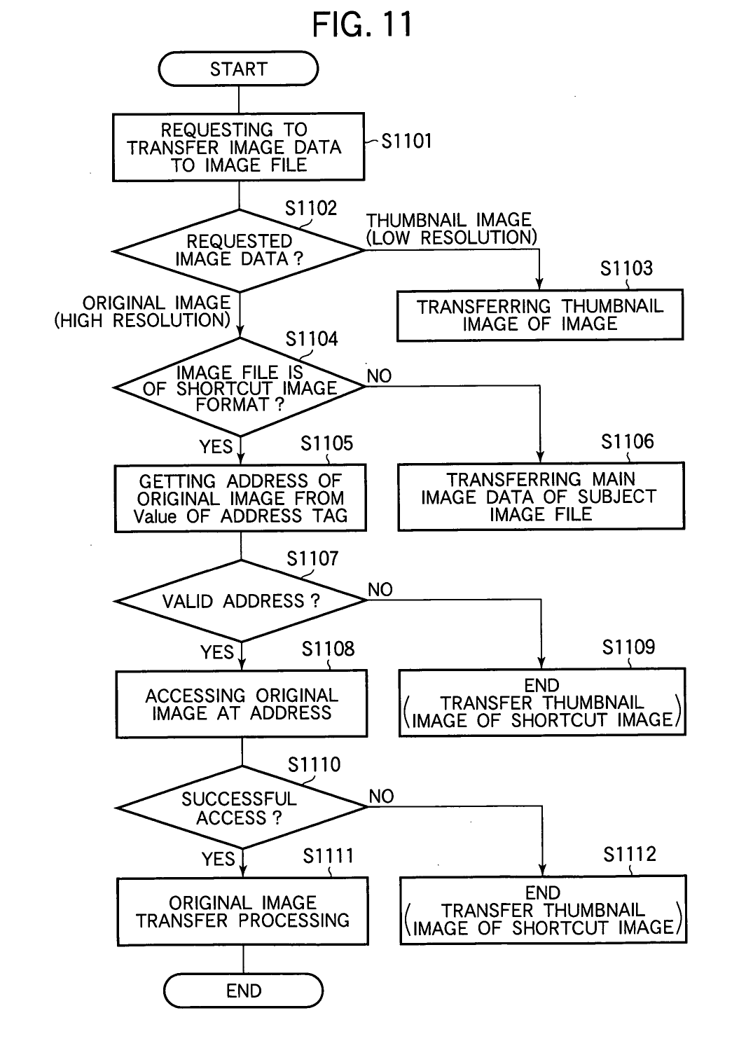

In the following there will be explained, with reference to FIG. 11, details of an image data transfer procedure shown in FIGS. 8 to 10B.

FIG. 11 shows an image data transfer sequence executed by the client terminal 501. The sequence in FIG. 11 may be stored as a control program for the CPU (504) in an HDD (506) or a memory (505). A program corresponding to the control sequence in FIG. 11 may be supplied in an arbitrary path, and may be stored in such memory media from the time of the product shipment or may be supplied in a memory medium such as an MO, a CD-ROM or a DVD-ROM, or through a network.

In FIG. 11, when the application A on the client terminal 501 generates, in a step S1101, an image data transfer request to the shortcut image file 301 under the management of the application B, there is executed a process starting from a step S1102. Otherwise, when the application A on the client terminal 501 generates an image data transfer request to the original image file 302 under the management of the application C, there is executed a process starting from a step S1102.

In the present embodiment, as shown in FIGS. 8-10B, the application A (such as a browser or an image viewer) requests a transfer of image data to the application B (such as an OS) which manages the shortcut image file 302 or the application C of the server 502 (such as an HTTP server).

Then, in a step S1102, the client terminal 501 discriminates whether the image data requested from the application A are the thumbnail image data 107 of the lower resolution or the original image data 106 of the higher resolution.

The discrimination in the step S1102 may be for example executed, at the user operation requesting the image data through the predetermined interface, on the basis of a resolution of the designated image data. Otherwise it may be executed by a default value set in advance by the application. For example, the application may be so set in advance as to handle only the thumbnail image data of the lower resolution. Otherwise the discrimination of the step S1102 may be executed, in case the application A is for example a WEB browser, by a method designating the image data display on a WEB page. For example, in case of a designation by a tag such as HTML <IMG> for display on the WEB page, there is identified a request for the thumbnail image data 302 of the lower resolution. On the other hand, a request for the original image data 301 of the higher resolution is identified in case “Display Image”, “View Image” (displaying an image only in a page), “Save Image(download)” or “Save Image” is selected in menu items in the WEB browser and a display thereof on another image screen is designated.

In case the image data requested in the step S1102 are identified as the thumbnail image data 107 of the low-resolution, the client terminal 501 executes, in a step S1103, a process of transferring the thumbnail image data 107 of the shortcut image file 302, under the management of the application B, to the application A. This operation is applicable in case, as shown in FIG. 9, the user only wishes to know the summary of the shortcut image file 302 “a” (namely when the user does not require the original image data 106 of the original image file 301 “A”).

In the step S1103, in case the image data requested in the step S1102 are the thumbnail image data of the low-resolution and the image file constituting the subject of the image data transfer request is in conformity with the DCF standard, the thumbnail image data 107 stored as the DCF basic thumbnail image of such image file may be transferred regardless whether such image file is in the shortcut image format. Also even if the image file constituting the subject of the image data transfer request is not in conformity with the DCF standard and does not include the thumbnail image data 107, the application A may reduce the image data contained in such image file to a necessary resolution thereby generating the thumbnail image data 107.

The present embodiment does not specify the details of the image data transfer, and for example the application B may develop the thumbnail image file 302 in conformity with the DCF standard in the shortcut image file 302 “a” and transfer only the thumbnail image data 107 to the application A.

On the other hand, in case the image data requested in the step S1102 are identified as the original image data 106 of the high-resolution, the client terminal 501 discriminates, in a step S1104, whether the application has generated an image data transfer request for the shortcut image file 302 under the management of the application B. In case the step S1104 identifies that an image data transfer request is generated for the shortcut image file 302, the client terminal 501 executes a process of acquiring the original image file 301 (starting from S1105). Also in case the step S1104 identifies that the image data transfer request is not generated for the shortcut image file 302, the client terminal 501 identifies that the request is generated for the original image file 301 and executes a process (S1106) of transferring the original image data 106 of the original image file 301.

The present embodiment does not particularly specify a criterion for the discrimination whether the image data transfer request is generated for the shortcut image file 302, and such discrimination can be executed, for example, in accordance with whether an arbitrary Exif tag (for example a maker notes tag) of the image file, constituting the subject of the image data transfer request, records a flag indicating the shortcut image file 302. The discrimination may also be executed by whether the image file, constituting the subject of the image data transfer request, contains an address tag 102.

In case the step S1104 identifies that the image file, constituting the subject of the image data transfer request, is not the shortcut image file 302, the client terminal 501 identifies such image file itself as the original image file 301 and is therefore not required to acquire the original image file 301 anew. Thus, a step S1106 executes an ordinary image file development process in which the original image data 106 of the original image file 301, under the management of the application B, is transferred to the application A.

Also, even in case the step S1104 identifies that the image file constituting the subject of the image data transfer request is the shortcut image file 302, when the original image data 106 are present, the original image transfer process starting from the step S1105 may be dispensed with, and, in the step S1106, the client terminal 501 can transfer the original image data 106, contained in the shortcut image file 302 under the management of the application B, to the application B. Also even in case the image file constituting the subject of the image data transfer request is the shortcut image file 302 and the original image data 106 are present, it is naturally possible, disregarding such original image data S1106, to execute a process of acquiring the original image file 301 in and after the step S1105.

In case the step S1104 identifies that the image file constituting the subject of the image data transfer request is the shortcut image file 302, the application A of the client terminal 501 acquires the original image data 106 under the management of the application C of the server 502. In a step S1105, the application A of the client terminal 501 acquires the address tag 102 from the shortcut image file 302 under the management of the application B. More specifically, from the Value recorded in the address tag 102 of the shortcut image file 302 as explained in FIGS. 2 to 4, there is obtained a character string indicating the storage location of the original image file 301. For example, in the present embodiment, “http://www.xxxx.co.jp/original-image/A.JPG” is acquired, from the address tag 102 of the shortcut image file 302 “a”, as a character string indicating the storage location of the original image data 106.

Thereafter, a step S1107 discriminates whether the character string described in the acquired address tag 102 is an effective value. However, the discrimination in the step S1107 may be dispensed with. In case the step S1107 identifies that the character string described in the acquired address tag 102 is ineffective, a step S1109 executes an error process. In the present embodiment, in a step S1109, the application B of the client terminal 501 transfers, as a replacement for the original image data 106, the thumbnail image data 107 of the shortcut image file 302 to the application A. Otherwise, the application B of the client terminal 501 transfers, as a replacement for the original image data 106, the reduced image data 106a of the shortcut image file 302 to the application A. Otherwise, the process may be terminated by an error notice of an effect that “no effective tag present”. The character string described in the address tag may be judged as ineffective for example in case the address of the server 502 cannot be decoded in a DNS search.

In case the step S1107 identifies that the character string described in the address tag 102 is effective, the client terminal 501 executes, in a step S1108, a process for acquiring the original image file 301 under the management of the application C in the server 502, in conformity with the character string described in the address tag 102. The present embodiment does not particularly specify the process for acquiring the original image file 301, and for example a data transfer request by an arbitrary data transfer protocol (such as FTP or HTTP) is made from the application A of the client terminal 510 to the application C of the server 502.

Then a step S1110 discriminates whether the application A of the client terminal 501 has succeeded in the access to the original image file 301 under the management of the application C of the server 502.

In case the step S1110 identifies a failure, the client terminal executes an error process in a step S1112. In the present embodiment, in a step S1112, the application A of the client terminal 501 requests the transfer of the thumbnail image data 107 of the shortcut image file 302 to the application B, which then transfers the thumbnail image data 107 to the application A. Then the application A of the client terminal 501 displays a summary of the image on the image output means 511, in conformity with the thumbnail image data 107 transferred from the application B instead of the original image data 106. Otherwise the application A of the client terminal 501 may terminate the process by executing a process of showing a message indicating “failed access to the original image” on the display of the image output means 511.

The present embodiment does not particularly specify a criterion for discriminating whether the access from the application A of the client terminal 501 to the original image file 301 under the management of the application C of the server 502 is successful, but such discrimination is possible for example by identifying a result code returned from the server 502 to the client terminal 501, for example in case the original image file 301 is absent in the location indicated by the character string described in the address tag 102, in case of an excessive traffic in the server 502, or in case of a failed setting in the network connection of the client terminal 501.

In case, in the step S1110, the transfer request of the application A of the client terminal 501 is permitted by the application C of the server 502, by a data transfer protocol (FTP or HTTP) for the original image file 301 “A” under the management thereof, and a successful access of the application of the client terminal 501 to the original image file 301 under the management of the application C of the server 502 is thus identified, a process of a step S1111 is executed. In the step S1111, the application A of the client terminal 501 executes a process of downloading the original image data 106 of the original image file 301 “A” under the management of the application C of the server 502. The present embodiment does not particularly specify the details of the downloading process for the original image data 106, and for example the application C of the server 502 develops the original image file 301 “A” under the management thereof, then extract the original image data 106 stored as main image data according to the DCF standard and execute a downloading to the application A of the client terminal 501 through the network 503 and according to an arbitrary data transfer protocol.

The image data transferred in the aforementioned steps S1103, S1106, S1109, S1111 and S1112 are naturally processed according to the user instruction that has caused such transfer. For example, in case of WEB browser, there is executed an ordinary display of the aforementioned image in a WEB page, an image display corresponding to “Display Image” or “View Image” (displaying an image only in a page) instructed by the user, or a saving of the image file data corresponding to “Save Image(download)” or “Save Image” instructed by the user.

In the present embodiment, as explained in the foregoing, as long as the client terminal 501 has the shortcut image file 302, the application A on the client terminal 501 can acquire whenever necessary the storage location of the original image file 301 “A” from the address tag 102 of the shortcut image file 302 “a” under the management of the application B, and can thus acquire the original image data 106 of a large data size with the high-resolution of the original image file 301 “A” under the management of the application C of the server 501.

Also in the present embodiment, in case the application A of the client terminal 501 wishes to acquire only the thumbnail image data 107 of the shortcut image file 302 “a” or in case it wishes to acquire the original image data 106 of the original image file 301 “A” under the management of the application C of the server 501 but fails to acquire the original image data 106 because of absence of the address tag 102 of the shortcut image file 302 or absence of the original image file 301 in the storage location indicated by the address tag 102, the thumbnail image data 107 or the reduced image data 106a of the shortcut image file 203 “a” under the management of the application B of the client terminal 501 are transferred to the application A, which can acquire and display a rough image in place for the original image data 106.

Particularly in the present embodiment, as the shortcut image file 302 held in the client terminal 501 stores the thumbnail image data 107 or the reduced image data 106a, a summary of the image can be known from such thumbnail image data 107 or such reduced image data 106a even when the original image file 301 stored in the server 502 is erased, so that the shortcut image file 302 can be utilized as a minimum backup purpose.

In such case where the original image file is erased, in order to utilize the thumbnail image data 107 or the reduced image data 106a of the shortcut image file 302 for a display, a saving or a recording output as a backup of the original image data 106, there is added a subroutine which, in case the original image file 301 under the management of the application C of the server 502 is identified unacquirable, allows the application A of the client terminal 501 to acquire the the thumbnail image data 107 or the reduced image data 106a of the shortcut image file 302.

In contrast to the present embodiment, a prior technology, in which a personal computer receives an e-mail describing the link of the original image file 301 by an installed mailer, cannot display the image nor even the summary of the image in case the original image file 301 at such link is erased.

As explained in the foregoing, the present embodiment is featured in recording an image in divided manner utilizing an original image file 301 and a thumbnail image file 302 including an address tag 102 indicating the storage location thereof, and, in case of utilizing the original image data 301 (for example for a transfer, a display, a printing, a saving or a copying), transferring the original image file 301 in conformity with the address tag 102 of the shortcut image file 301.

Also in the present embodiment, the original image file 301 of a large data size need not be transmitted, received or hold always but can be transmitted or received only when necessary, by transmitting, receiving or holding the thumbnail image file 302 of a small data size only, whereby a communication traffic can be reduced and a burden on the memory of the server 502 and the client terminal 501 can be alleviated.

The present embodiment transfers thumbnail image data 107 or reduced image data 106a of the shortcut image file 302 in case the original image file 301 cannot be downloaded. Therefore, in case the original image file 301n cannot be downloaded, there can be displayed the thumbnail image data 107 or the reduced image data 106a of the shortcut image file 302 as a summary of the original image data 106 and as a minimum backup.

The object of the present invention can also be achieved by providing a storage medium storing program codes for performing the aforesaid processes to an image sensing system or apparatus, reading the program codes, by a CPU or MPU of the image sensing system or apparatus, from the storage medium, then executing the program.

In this case, the program codes read from the storage medium realize the functions according to the embodiments, and the storage medium storing the program codes constitutes the invention.

Further, the storage medium, such as a floppy disk, a hard disk, an optical disk, a magneto-optical disk, CD-ROM, CD-R, a magnetic tape, a non-volatile type memory card, and ROM, and computer network, such as LAN (local area network) and WAN (wide area network), can be used for providing the program codes.

Furthermore, besides aforesaid functions according to the above embodiments are realized by executing the program codes which are read by a CPU of the image sensing system or apparatus, the present invention includes a case where an OS (operating system) or the like working on the computer performs a part or entire processes in accordance with designations of the program codes and realizes functions according to the above embodiments.

Furthermore, the present invention also includes a case where, after the program codes read from the storage medium are written in a function expansion card which is inserted into the image sensing system or apparatus or in a memory provided in a function expansion unit which is connected to the image sensing system or apparatus, CPU or the like contained in the function expansion card or unit performs a part or entire process in accordance with designations of the program codes and realizes functions of the above embodiments.

In a case where the present invention is applied to the aforesaid storage medium, the storage medium stores program codes corresponding to the flowchart of FIGS. 6, 7 and 11 described in the embodiments.

The present invention is not limited to the above embodiments and various changes and modifications can be made within the spirit and scope of the present invention. Therefore to apprise the public of the scope of the present invention, the following claims are made.

This application claims priorities from Japanese Patent Applications No. 2004-141767 filed May 12, 2004 and No. 2004-329905 filed Nov. 15, 2004, which are hereby incorporated by reference herein.

1. An image data management method for managing image data of a high-resolution included in an original image file, comprising:
an acquisition step of acquiring image data of a low-resolution, corresponding to the image data of the high-resolution;
a preparation step of preparing a shortcut image file including the acquired image data of the low-resolution; and
an attaching step of attaching, to the prepared shortcut image file, an address tag indicating a location where the original image file is stored.

2. A method according to claim 1, wherein the acquisition step further includes an extraction step of extracting the image data of the low-resolution from the original image file.

3. A method according to claim 1, wherein the acquisition step further includes a generation step of generating the image data of the low-resolution from the image data of the high-resolution included in the original image file.

4. A method according to claim 1, wherein the shortcut image file does not include the image data of the high-resolution.

5. A method according to claim 1, wherein the original image file is in conformity with a DCF standard.

6. A method according to claim 1, wherein the shortcut image file is in conformity with the DCF standard and stores a NULL value as a main image of the DCF standard.

7. A method according to claim 1, wherein the shortcut image file is in conformity with the DCF standard and stores the image data of the low-resolution as a main image of the DCF standard.

8. A method according to claim 1, further comprising:
a step of generating third image data of a resolution lower than that of the image data of the high-resolution and higher than that of the image data of the low-resolution;
wherein the shortcut image file is in conformity with the DCF standard and stores the third image data as a main image of the DCF standard.

9. A method according to claim 1, wherein the address tag is generated from character string information indicating a storage position of the original image file and a file name of the original image file.

10. A method according to claim 1, further comprising:
a step of setting a storage position of the original image file indicated in the address tag.

11. A method according to claim 1, wherein the original image file is stored in a server apparatus, the shortcut image file is stored in a client terminal, and the server apparatus and the client terminal are arranged so as to communicate with each other through a network.

12. A method according to claim 1, wherein the original image file is stored in a first folder, and the shortcut image file is stored in plural second folders.

13. An image data management system having plural information processing apparatuses connected by a network, for managing image data of a high-resolution included in an original image file, comprising:
acquisition means which acquires image data of a low-resolution, corresponding to the image data of the high-resolution;
preparation means which prepares a shortcut image file including the acquired image data of the low-resolution;
attaching means which attaches, to the prepared shortcut image file, an address tag indicating a location where the original image file is stored;
first storage means which stores the original image file; and
second storage means which stores the shortcut image file.

14. A system according to claim 13, wherein the acquisition means further includes extraction means which extracts the image data of the low-resolution from the original image file.

15. A system according to claim 13, wherein the acquisition means further includes generation means which generates the image data of the low-resolution from the image data of the high-resolution included in the original image file.

16. A system according to claim 13, wherein the shortcut image file does not include the image data of the high-resolution.

17. A system according to claim 13, wherein the original image file is in conformity with a DCF standard.

18. A system according to claim 13, wherein the shortcut image file is in conformity with the DCF standard and stores a NULL value as a main image of the DCF standard.

19. A system according to claim 13, wherein the shortcut image file is in conformity with the DCF standard and stores the image data of the low-resolution as a main image of the DCF standard.

20. A system according to claim 13, further comprising:
means which generates third image data of a resolution lower than that of the image data of the high-resolution and higher than that of the image data of the low-resolution;
wherein the shortcut image file is in conformity with the DCF standard and stores the third image data as a main image of the DCF standard.

21. A system according to claim 13, wherein the address tag is generated from character string information indicating a storage position of the original image file and a file name of the original image file.

22. A system according to claim 13, further comprising:
means which sets a storage position of the original image file indicated in the address tag.

23. A system according to claim 13, wherein the first storage means and the second storage means are respectively provided in independent information processing apparatuses.

24. A system according to claim 13, wherein the first storage means and the second storage means are respectively independent directories.

25. A system according to claim 13, wherein the acquisition means utilizes the original image file stored in third storage means; and
the system further comprising;
detection means which detects that the original image file is stored in the first storage means; and
erasing means which erases the original image file stored in the third storage means in response to the detection.

26. An image data management apparatus for managing image data of a high-resolution included in an original image file, comprising:
acquisition means which acquires image data of a low-resolution, corresponding to the image data of the high-resolution;
preparation means which prepares a shortcut image file including the acquired image data of the low-resolution; and
attaching means which attaches, to the prepared shortcut image file, an address tag indicating a location where the original image file is stored.

27. An apparatus according to claim 26, wherein the acquisition means further includes extraction means which extracts the image data of the low-resolution from the original image file.

28. An apparatus according to claim 26, wherein the acquisition means further includes generation means which generates the image data of the low-resolution from the image data of the high-resolution included in the original image file.

29. An apparatus according to claim 26, wherein the shortcut image file does not include the image data of the high-resolution.

30. An apparatus according to claim 26, wherein the original image file is in conformity with a DCF standard.

31. An apparatus according to claim 26, wherein the shortcut image file is in conformity with the DCF standard and stores a NULL value as a main image of the DCF standard.

32. An apparatus according to claim 26, wherein the shortcut image file is in conformity with the DCF standard and stores the image data of the low-resolution as a main image of the DCF standard.

33. An apparatus according to claim 26, further comprising:
means which generates third image data of a resolution lower than that of the image data of the high-resolution and higher than that of the image data of the low-resolution;
wherein the shortcut image file is in conformity with the DCF standard and stores the third image data as a main image of the DCF standard.

34. An apparatus according to claim 26, wherein the address tag is generated from character string information indicating a storage position of the original image file and a file name of the original image file.

35. An apparatus according to claim 26, further comprising:
means which sets a storage position of the original image file indicated in the address tag.

36. An apparatus according to claim 26, wherein the original image file is stored in a server apparatus, the shortcut image file is stored in a client terminal, and the server apparatus and the client terminal are arranged so as to communicate with each other through a network.

37. An apparatus according to claim 26, wherein the original image file is stored in a first folder, and the thumbnail image file is stored in plural second folders.

38. An apparatus according to claim 26, further comprising:
transmission means which transmits the original image file to an external apparatus through a network;
detection means which detects whether the original image file is stored in the external apparatus; and
erasing means which erases the original image file from an internal memory apparatus in response to the detection.

39. An image data transfer process method, comprising:
an acquisition step of acquiring an address tag indicating a storage location of an original image file including image data of a high-resolution from a shortcut image file, wherein the shortcut image file includes image data of a low-resolution corresponding to the image data of the high-resolution; and
a request step of requesting a transfer of the image data of the high-resolution of the original image file based on the address tag.

40. A method according to claim 39, further comprising:
a reception step of receiving the image data of the high-resolution of the original image file, corresponding to the transfer request.

41. A method according to claim 39, wherein the shortcut image file does not include the image data of the high-resolution.

42. A method according to claim 39, wherein the original image file is in conformity with a DCF standard.

43. A method according to claim 39, wherein the shortcut image file is in conformity with the DCF standard and stores a NULL value as a main image of the DCF standard.

44. A method according to claim 39, wherein the shortcut image file is in conformity with the DCF standard and stores the image data of the low-resolution as a main image of the DCF standard.

45. A method according to claim 39, wherein the shortcut image file includes third image data of a resolution lower than that of the image data of the high-resolution and higher than that of the image data of the low-resolution.

46. A method according to claim 39, further comprising:
a discrimination step of discriminating whether a transfer of the image data of the high-resolution in response to the transfer request is possible; and
a transfer step of transferring the image data of the low-resolution included in the shortcut image file according to the discrimination.

47. An image data management system including plural information processing apparatuses connected by a network, for transferring image data, comprising:
means which acquires an address tag indicating a storage location of an original image file including image data of a high-resolution from a shortcut image file, wherein the shortcut image file includes image data of a low-resolution corresponding to the image data of the high-resolution;
request means which requests a transfer of the image data of the high-resolution of the original image file based on the address tag;
first transmission means which transmits the image data of the high-resolution of the original image file in response to the transfer request; and
second transmission means which transmits the image data of the low-resolution of the shortcut image file including the address tag of the transfer request.

48. A system according to claim 47, wherein the shortcut image file does not include the image data of the high-resolution.

49. A system according to claim 47, wherein the original image file is in conformity with a DCF standard.

50. A system according to claim 47, wherein the shortcut image file is in conformity with the DCF standard and stores a NULL value as a main image of the DCF standard.

51. A system according to claim 47, wherein the shortcut image file is in conformity with the DCF standard and stores the image data of the low-resolution as a main image of the DCF standard.

52. A system according to claim 47, wherein the shortcut image file includes third image data of a resolution lower than that of the image data of the high-resolution and higher than that of the image data of the low-resolution.

53. A system according to claim 47, further comprising:
discrimination means which discriminates whether a transfer of the image data of the high-resolution in response to the transfer request is possible;
wherein a transmission is executed by either of the first transmission means and the second transmission means according to the discrimination.

54. An image data transfer processing apparatus comprising:
acquisition means which acquires an address tag indicating a storage location of an original image file including image data of a high-resolution from a shortcut image file, wherein the shortcut image file includes image data of a low-resolution corresponding to the image data of the high-resolution;
request means which requests a transfer of the image data of the high-resolution of the original image file based on the address tag.

55. An apparatus according to claim 54, further comprising:
reception means which receives the image data of the high-resolution of the original image file, in response to the transfer request.

56. An apparatus according to claim 54, wherein the shortcut image file does not include the image data of the high-resolution.

57. An apparatus according to claim 54, wherein the original image file is in conformity with a DCF standard.

58. An apparatus according to claim 54, wherein the shortcut image file is in conformity with the DCF standard and stores a NULL value as a main image of the DCF standard.

59. An apparatus according to claim 54, wherein the shortcut image file is in conformity with the DCF standard and stores the image data of the low-resolution as a main image of the DCF standard.

60. An apparatus according to claim 54, wherein the shortcut image file includes third image data of a resolution lower than that of the image data of the high-resolution and higher than that of the image data of the low-resolution.

61. An apparatus according to claim 54, further comprising:
discrimination means which discriminates whether a transfer of the image data of the high-resolution in response to the transfer request is possible; and
transfer means which transfers the image data of the low-resolution included in the shortcut image file, according to the discrimination.

62. A program for causing a computer to execute an image data management method for managing image data of a high-resolution included in an original image file, comprising:
an acquisition step of acquiring image data of a low-resolution, corresponding to the image data of the high-resolution;
a preparation step of preparing a shortcut image file including the acquired image data of the low-resolution; and
an attaching step of attaching, to the prepared shortcut image file, an address tag indicating a location where the original image file is stored.

63. A program for causing a computer to execute an image data transfer processing method, comprising:
an acquisition step of acquiring an address tag indicating a storage location of an original image file including image data of a high-resolution, in which the shortcut image file includes image data of a low-resolution corresponding to the image data of the high-resolution; and
a request step of requesting a transfer of the image data of the high-resolution of the original image file based on the address tag.
